(19) United States
(12) Patent Application Publication
(10) Pub. No.: US 2026/0252798 A1
(43) Pub. Date: Aug. 27, 2026

(54) HALLUCINATION DETECTION IN SUMMARY VALIDATION GENERATED BY AI

(71) Applicant: International Business Machines Corporation, Armonk, NY (US)

(72) Inventors: Abhay Choudhary, MULHUDDART (IE); Akash Bhargava, MULHUDDART (IE)

(21) Appl. No.: 19/065,763

(22) Filed: Feb. 27, 2025

(51) Int. Cl. G06F 40/284; G06F 16/34

(52) U.S. Cl. CPC G06F 40/284; G06F 16/345

(57) ABSTRACT

An example operation includes one or more of executing a machine learning (ML) model on an input text to generate an output that comprises a summary of the input text, capturing the input text and the output from the ML model, determining a contextual hallucination exists in the output based on a comparison of generative content included in the summary and input content included in the input text, determining a factual hallucination exists in the output based on a first group of token values included in the summary and a second group of token values included in the input text, and displaying the contextual hallucination and the factual hallucination on a graphical user interface (GUI).

### BACKGROUND

Generative machine learning (ML), also known as generative artificial intelligence (AI), is a type of machine learning that creates new data that is similar to the data that was used to train the model. Generative models are advanced neural networks that learn the patterns and distributions in training data, and then use that knowledge to generate new content. Meanwhile, a hallucination occurs when a generative model produces inaccurate or fabricated results. The problem of hallucinations is a significant issue in ML/AI, because it limits the model's ability to interpret context and facts properly.

### SUMMARY

One example embodiment provides a method that may include one or more of executing a machine learning (ML) model on an input text to generate an output that comprises a summary of the input text, capturing the input text and the output from the ML model, determining a contextual hallucination exists in the output based on a comparison of generative content included in the summary and input content included in the input text, determining a factual hallucination exists in the output based on a first group of token values included in the summary and a second group of token values included in the input text, and displaying the contextual hallucination and the factual hallucination on a graphical user interface.

Another example embodiment provides a computer system that may include a processor set, a set of one or more computer-readable storage media, and program instructions, collectively stored in the set of one or more storage media, that cause the processor set to perform computer operations that may include one or more of executing a machine learning (ML) model on an input text to generate an output that comprises a summary of the input text, capturing the input text and the output from the ML model, determining a contextual hallucination exists in the output based on a comparison of generative content included in the summary and input content included in the input text, determining a factual hallucination exists in the output based on a first group of token values included in the summary and a second group of token values included in the input text, and displaying the contextual hallucination and the factual hallucination on a graphical user interface.

A further example embodiment provides a computer program product that may include a set of one or more computer-readable storage media, and program instructions, collectively stored in the set of one or more computer-readable storage media, for causing a processor set to perform computer operations that may include one of more of executing a machine learning (ML) model on an input text to generate an output that comprises a summary of the input text, capturing the input text and the output from the ML model, determining a contextual hallucination exists in the output based on a comparison of generative content included in the summary and input content included in the input text, determining a factual hallucination exists in the output based on a first group of token values included in the summary and a second group of token values included in the input text, and displaying the contextual hallucination and the factual hallucination on a graphical user interface.

### BRIEF DESCRIPTION OF THE DRAWINGS

FIG. 1 is a diagram illustrating a computing environment according to an embodiment of the instant solution.

FIG. 2A is a diagram illustrating a process of detecting a hallucination in a summary generated by an ML model according to an embodiment of the instant solution.

FIG. 2B is a diagram illustrating examples of various types of hallucinations according to embodiments of the instant solution.

FIG. 2C is a diagram illustrating a multi-stage hallucination determination process according to embodiments of the instant solution.

FIG. 2D is a diagram illustrating a process of retraining the ML model based on the hallucinations according to an embodiment of the instant solution.

FIG. 3A is a diagram illustrating a process of detecting contextual-based hallucinations according to an embodiment of the instant solution

FIG. 3B is a diagram illustrating a process of identifying tokens of different types within input text and a summary according to an embodiment of the instant solution.

FIG. 3C is a diagram illustrating a process of detecting fact-based hallucinations based on the tokens of different types according to an embodiment of the instant solution.

FIG. 3D is a diagram illustrating an example of a scoring process for hallucinations according to an embodiment of the instant solution.

FIG. 4A is a flow diagram illustrating a method according to examples and features of the instant solution.

FIG. 4B is a flow diagram illustrating a method according to additional examples and features of the instant solution.

FIG. 5A is a system diagram illustrating integration of an AI model into any decision point according to the examples and features of the instant solution.

FIG. 5B is a diagram illustrating a process for developing an AI model that supports AI-assisted computer decision points according to the examples and features of the instant solution.

FIG. 5C is a diagram illustrating a process for utilizing an AI model that supports AI-assisted computer decision points according to examples and features of the instant solution.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

According to various embodiments, a machine learning model such as a generative model may receive, as input, text content such as an article of content, a message, multiple messages, text from a book, text from a magazine, text from a news story, and the like, and generate an output that includes a “summary” of the text content. The summary may include significantly less content that is also in descriptive form, and which summarizes the text content input to the ML model. As noted above, there is always the chance of hallucinations that can occur when generating such as summary of content. The hallucinations may differ between different ML models making some ML models worse than others for certain tasks.

However, validating a text summary against the actual input data is not an easy task. This becomes even more difficult if the summary has fact-based hallucinations, context-based hallucinations, or both. Related solutions such as spacy embedding models etc. are not designed to tackle this problem. Meanwhile, transformer-based models do a fair job in detecting contextual hallucination but are not designed to tackle fact-based hallucinations. Thus, validation of fact-based hallucinations remains a challenging task.

The example embodiments are directed to a system that can verify a summarization generated by an ML model and generate a score/accuracy of the ML based on the verification. The system may consider both contextual hallucinations and fact-based hallucinations. A contextual hallucination occurs when the output content contradicts itself whereas a fact-based hallucination occurs when the model generates factually inaccurate or untrue content. For example, a contextual hallucination may occur when the system outputs information without any specific request for that information (e.g., the model suddenly provides a description of steak when the question was about fried chicken and mashed potatoes, etc.) Meanwhile, a fact-based hallucination may occur when the model outputs information that is not true (e.g., the capital of Spain is Paris, etc.)

The system described herein regularizes summarization scores of summaries when models hallucinate with either the context, the facts, or both. The system described herein provides two versions of regularization scores i.e., strict and lenient, that can be used by technical analysts. For example, the system can apply a fact-based hallucination penalty on top of transformer-based summary scores which gives a better validation score.

Unlike other methods, the fact-based hallucination method only uses similar tokens for comparison and scoring which is more efficient and a correct way. For example, a sentence with emails and URLs should not be compared with other sentences that do not have email or URL entities. Furthermore, because it is a token based solution, the system can compare unstructured input text and structured summary output by the model. The system may also take into consideration that some summaries may have partial entity matches and thus still give a score when a partial entity match is found.

Some of the benefits of the example embodiments include a hallucination detection system that can identify fact-based hallucinations rather as well as contextual-based hallucinations, and not just contextual-based hallucinations as is known in the art. By including fact-based hallucinations with contextual-based hallucinations, the system described herein can improve the hallucination detection process that exists. It can also improve the models themselves by creating a bigger feedback record with more information (fact-based hallucinations) that the model can be used to retrain the model. The result is a more accurate ML model. Furthermore, the speed at which the process can be performed is significantly faster in comparison to related hallucination detection systems because the fact-based hallucinations can be determined in parallel with the contextual-based hallucinations.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Thus, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

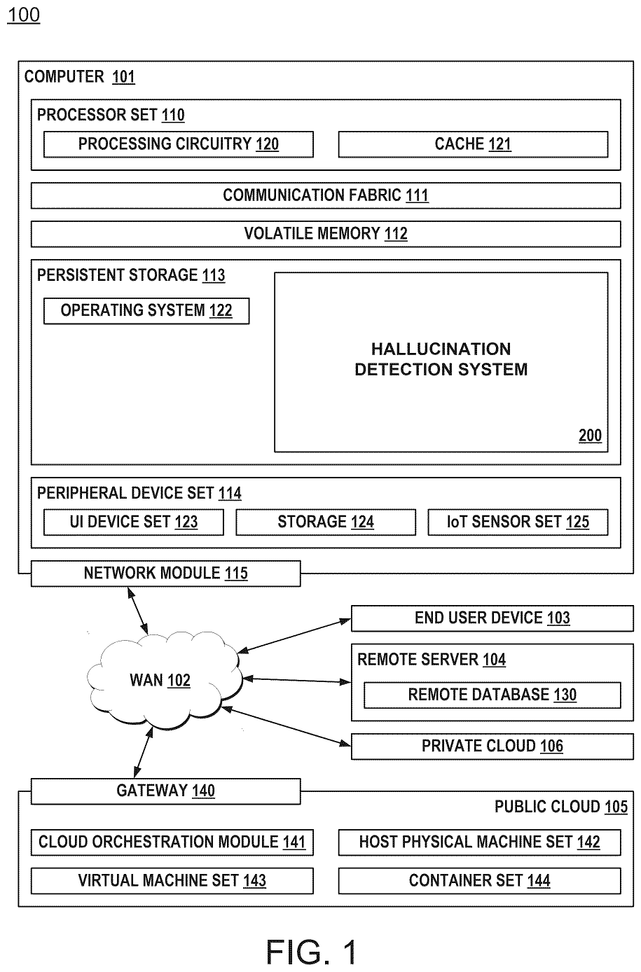

FIG. 1 illustrates a computing environment 100 that contains an example of an environment for the execution of at least some of the computer code involved in performing the inventive methods, such as hallucination detection system 200 which is configured to detect hallucinations that are generated by a ML model, AI model, or the like. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The example embodiments are directed to a system, such as a software application, for identifying hallucinations that have been generated by a machine learning (ML) model. The system is capable of detecting both contextual hallucinations and fact-based hallucinations using two separate mechanisms that can be executed in parallel by the system. In some embodiments, the system may be coupled to an input layer and an output layer of the ML model enabling the system to receive the input text provided to the ML model and the summary of the input text generated by the ML model from the input text.

For example, the system may import the actual input data and that summarized data produced by the ML model. The system may determine a similarity score between two texts using an embedding model which compares the vectorized input data to the vectorized summary to generate a similarity score between each part of the input text and the summary. The contextual-based analysis may be referred to as a first stage of the hallucination detection process.

In the second stage, the system may identify fact-based hallucinations. For the second stage, the system may create or otherwise execute named-entity recognition models (NERs) on the input text to extract tokens (values) corresponding to a plurality of facts such as email addresses, URLs, names, dates and the like, and segregate the tokens into groups based on the type of facts that they correspond to. The result is a plurality of groups of tokens corresponding to the plurality of types of facts. The system may perform the same process for the summary. The result is a plurality of groups of tokens for the input text and a plurality of groups of tokens for the summary.

Each group of tokens may be embedded in a shared embedding space, such as a vector space. For example, a group of tokens corresponding to email addresses in the input text may be converted into a group of embeddings that represent the group of email addresses, respectively. The same process may be performed for the group of email addresses in the summary. The embeddings between both groups may be compared to each other to see if the group of embeddings in the summary match the group of embeddings in the input text. If there is a mismatch of some kind, the system detects a fact-based hallucination. In other words, an email address has been changed or missed as a result of the ML model. In some embodiments, the system may perform a generic regular expression (RegEx) search for simple entity extraction. In the end if any entities are missed by the NER model, they may be caught/covered by the additional RegEx based entity extraction for example different formats of date and time

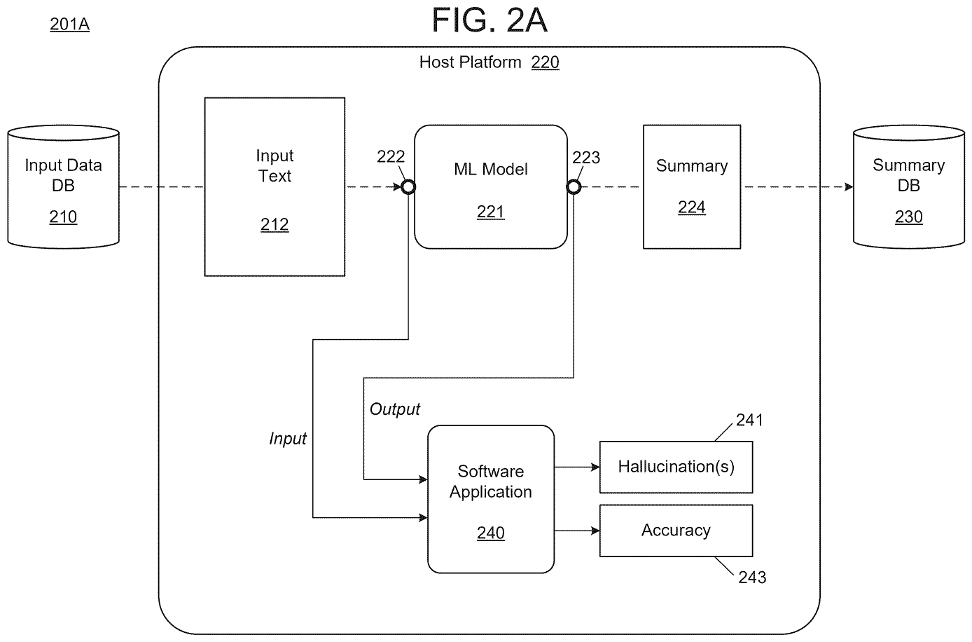

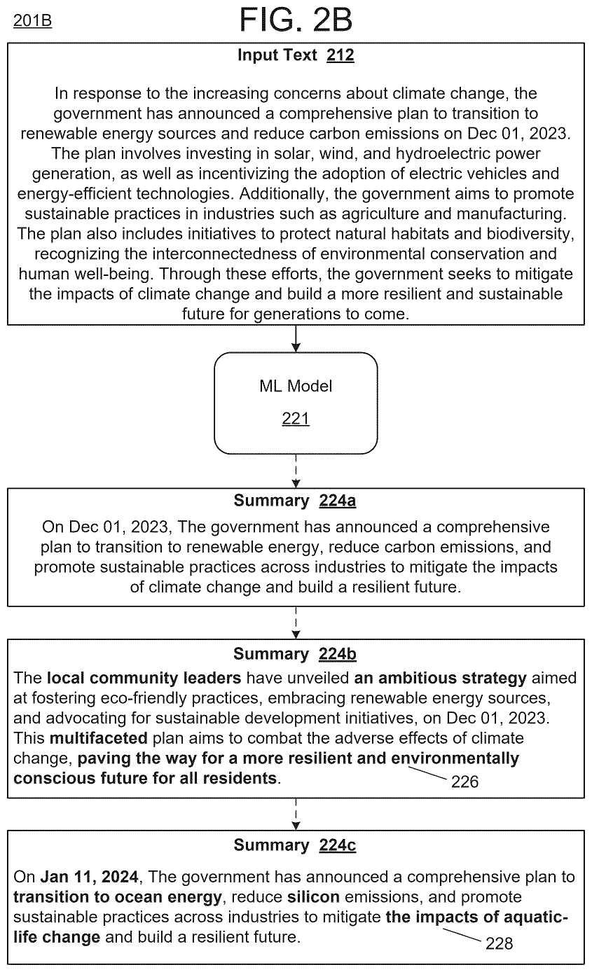

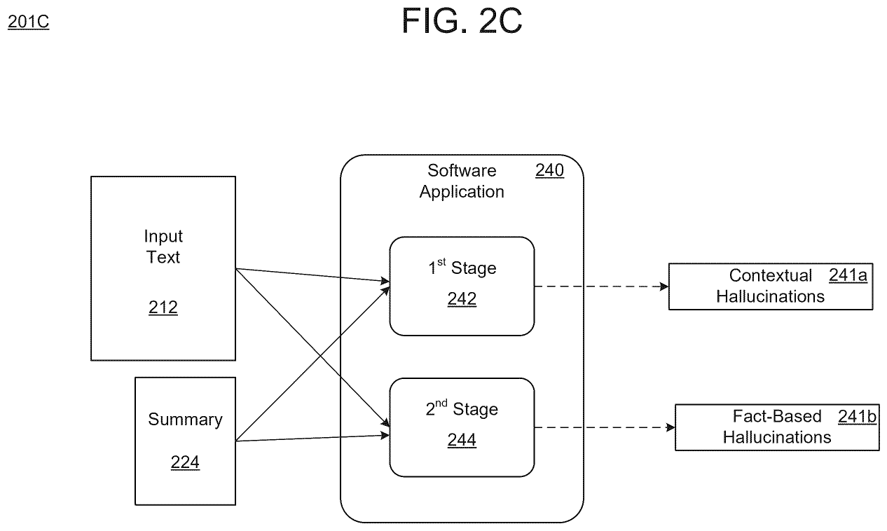

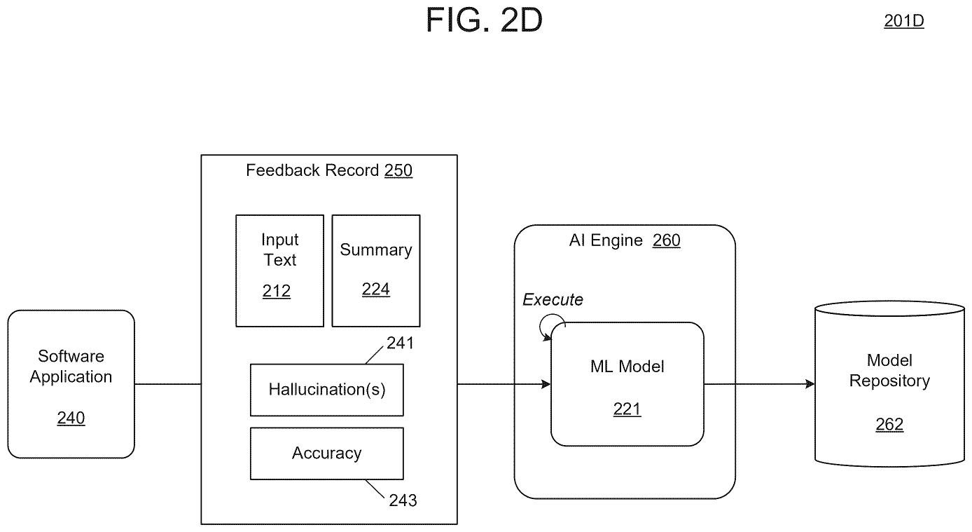

FIG. 2A illustrates a process 201A of detecting a hallucination in a summary 224 generated by a ML model 221 based on an input text 212 according to an embodiment of the instant solution. Referring to FIG. 2A, a host platform 220 may host the ML model 221 and a software application 240 which is made available to end users over the Internet, a private network, an on-premises system, and the like. For example, the ML model 221 may be a large language model (LLM), or other type of generative model which can receive the input text 212 (e.g., article, page of content, book, manual, code segment, etc.) from a database 210 and generate a descriptive summary of the input text 212 that summarizes the description of content within the input text 212 usually in significantly less words/sentences. The output from the ML model 221 is the summary 224. The summary 224 may be recorded in a summary database 230.

According to various embodiments, a software application 240 may detect hallucinations that occur within the summary 224, and which are generated by the ML model 221. The software application 240 can be attached/coupled to an input 222 of the ML model 221 and an output 223 of the ML model 221 enabling the software application 240 to capture both the input text 212 that goes into the input 222 of the ML model 221 and the summary 224 that is output by the output 223 of the ML model 221. For example, the input 222 may refer to an input layer of neurons in the LLM, while the output 223 may refer to an output layer of neurons in the LLM, however, embodiments are not limited thereto.

The software application 240 may ingest the input text 212 and the summary 224 and execute a multi-stage process as further described with respect to FIG. 2C. A first stage of the multi-stage process executed by the software application 240 may be used to detect contextual-based hallucinations while a second stage of the multi-stage process may be used to detect fact-based hallucinations. In some embodiments, the first stage and the second stage of the multi-stage process may be executed simultaneously. For example, execution times of the first stage and the second stage may share clock cycles of a multi-core processor where a first core executes the first stage and a second core executes the second stage at the same time (shared clock cycles).

In the example of FIG. 2A, the software application 240 determines hallucinations 241 along with the types of the hallucinations (e.g., contextual, fact-based, etc.) The software application 240 may also generate an accuracy value 243 that represents whether the summary 224 generated by the ML model 221 is of high enough quality that it is above a threshold and is therefore considered a success, or if the quality of the summary 224 is below a threshold which is considered a failure.

FIG. 2B illustrates a view 201B of examples of various types of hallucinations according to embodiments of the instant solution. Referring to FIG. 2B, a sample input text 212 is shown which includes a description of a government plan to transition from carbon-based energy sources to renewable energy sources. As an example, the ML model 221 may receive the input text 212 and generate different types of summaries as outputs. For example, the ML model 221 may generate a summary 224a which does not include a hallucination. As another example, the ML model 221 may generate a summary 224b which includes a contextual hallucination. As yet another example, the ML model 221 may generate a summary 224c which includes a fact-based hallucination.

For example, the summary 224a includes a group of sentences that can each be found from the input text 212. Therefore, the summary 224a is detected as being an accurate summary. Meanwhile, the summary 224b contains additional content 226 which is highlighted with bolded lettering and which cannot be identified from the input text 212, but which are not technically “incorrect”. The additional content 226 is therefore considered a contextual hallucination because the ML model 221 is creating an output with additional data that is not found in the input, but which is still considered accurate, or at least not inaccurate.

Meanwhile, the summary 224c contains additional data 228 which is highlighted with bolded lettering within the summary 224c and which contains data that is factually wrong/error. For example, the date of “Jan. 11, 2024” is wrong, and should be Dec. 1, 2023. As another example, the description of “silicon” emissions is incorrect, and it should be “carbon” emissions. These are just some examples. Therefore, the summary 224c is labeled as having fact-based hallucinations.

FIG. 2C illustrates a multi-stage hallucination determination process 201C according to embodiments of the instant solution. For example, the multi-stage hallucination determination process 201C may be used to detect both contextual-based hallucinations (e.g., summary 224b, etc.) and fact-based hallucinations (e.g., summary 224c, etc.) at the same time.

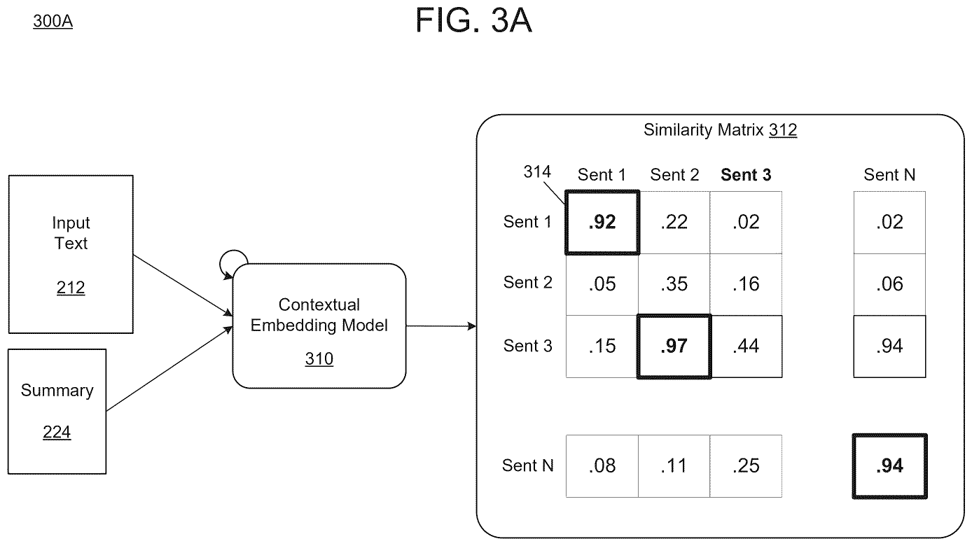

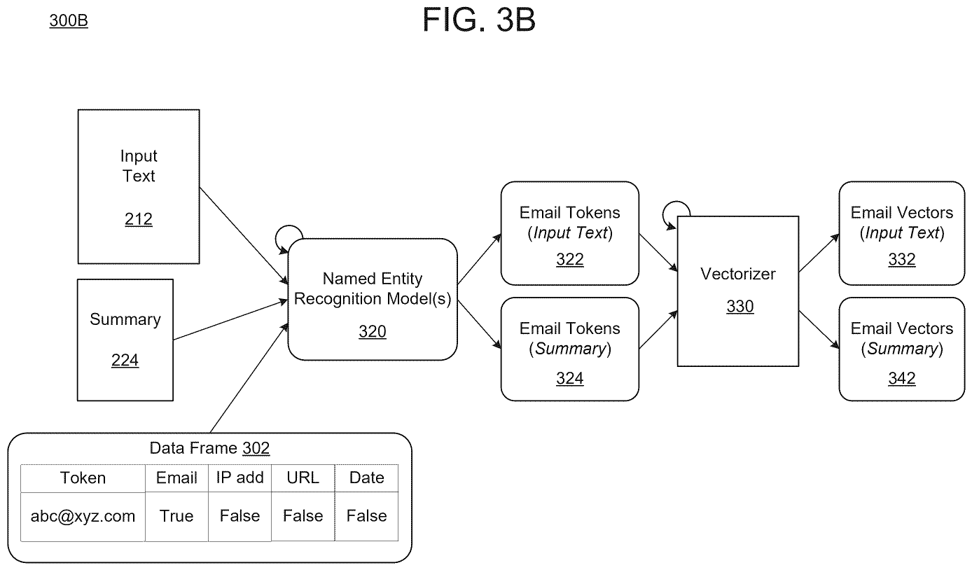

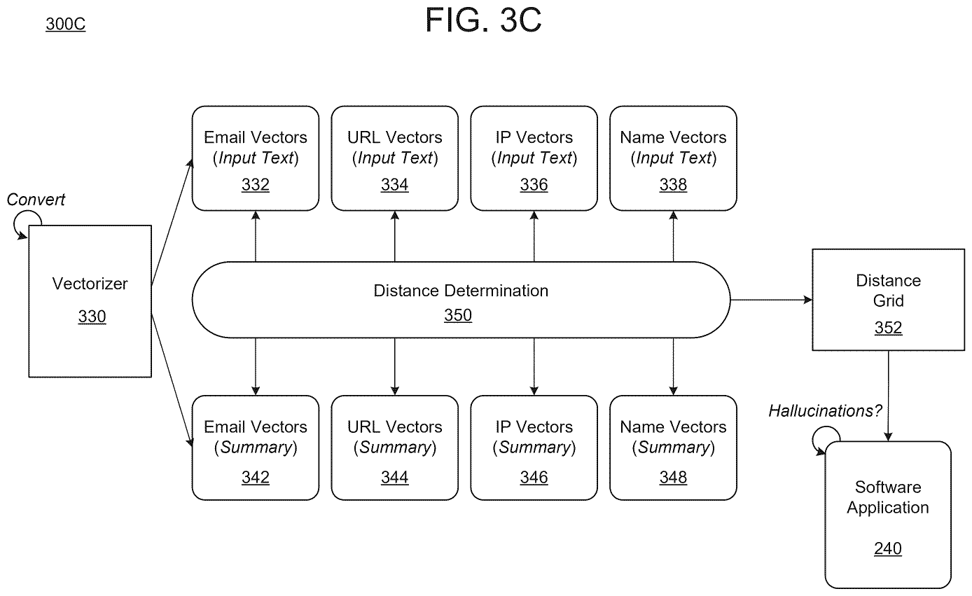

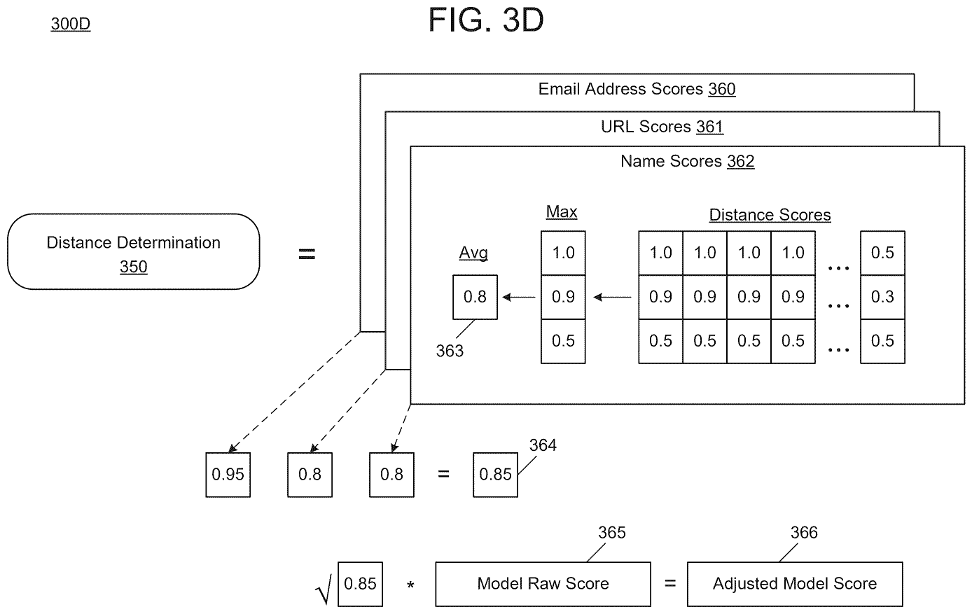

Referring to FIG. 2C, the software application 240 may ingest the input text 212 and the summary 224 and input both the input text 212 and the summary 224 to a first stage 242 of the hallucination determination process and a second stage 244 of the hallucination determination process. During the first stage 242, the software application may execute a process such as shown in the example of FIG. 3A, to identify contextual hallucinations 241a. Meanwhile, during the second stage 244, the software application 240 may execute a process such as shown in FIGS. 3B and 3C to identify fact-based hallucinations 241b. The contextual hallucinations 241a and the fact-based hallucinations 241b may be used to determine the accuracy value 243 of the ML model 221.

FIG. 2D illustrates a process 201D of retraining the ML model 221 based on the hallucinations according to an embodiment of the instant solution. According to various embodiments, the host platform 220 may also host an AI engine 260 that is capable of retraining the ML model 221. For example, the AI engine 260 may execute a script which causes the AI engine 260 to retrieve training data and input the training data to the ML model 221 while the model is executing. Referring to FIG. 2D, the software application 240 may generate a feedback record 250 that includes the input text 212, the summary 224 which is generated by the ML model 221, any hallucinations 241 that are detected and the types of hallucinations, and the accuracy value 243 of the summary 224.

According to various embodiments, the software application 240 may transfer the feedback record 250 to the AI engine 260 which causes the ML model 221 to execute on the feedback record 250 and learn from the content included in the feedback record 250. For example, the execution of the ML model 221 on the feedback record 250 may cause parameter values, weights, and the like, within the ML model 224 to be changed. The retrained model may be more accurate than it previously was as a result of the retraining process. Thus, the ML model 221 can continue to evolve and learn as it is being used. The retrained model may be stored in a model repository 262 and used during subsequent executions for generating summaries from input text.

FIG. 3A illustrates a process 300A of detecting contextual hallucinations according to an embodiment of the instant solution. For example, the process 300A may correspond to the first stage 242 of the contextual determination process performed by the software application 240 that is shown and described with respect to FIG. 2C. Referring to FIG. 3A, the software application may host or otherwise be communicably coupled to a contextual embedding model 310 such as a machine learning model that is configured to embed text content within a multi-dimensional embedding space, such as vector space, and perform a similarity analysis by determining a distance between two pieces of content within the multi-dimensional embedding space.

The contextual embedding model 310 may be a machine learning model that generates numerical representations of words, sentences, or paragraphs, where the representation of each word is dynamically adjusted based on its surrounding context within the text, capturing nuanced meanings and relationships between words that go beyond their standalone definition. The contextual embedding model 310 allows a word to have different meanings depending on the sentence it appears in, providing a more accurate semantic understanding of language.

Here, the contextual embedding model 310 receives the input text 212 and the summary 224 generated by the ML model 221, and converts the text content into n-dimensional embeddings. For example, each sentence in the input text 212 may be compared to each sentence in the summary 224. The purpose is to identify any sentences of the summary 224 that do not match any of the sentences in the input text 212 which indicates that the sentence is a hallucination. Here, the ML model 221 may generate a similarity score for each pair of sentences (e.g., a sentence in the summary and a sentence in the input text). In some embodiments, the ML model 221 may group together sentences from the input text 212 and compare them to individual sentences in the summary 224 because the summary 224 may combine a description of multiple sentences into a one sentence summary.

A similarity score may be calculated using a distance metric like cosine. Here, the similarity scores may be generated by the contextual embedding model 310 and stored in a similarity matrix 312 where each cell corresponds to a comparison between sentences (e.g., a sentence(s) from the input text and a sentence from the summary, etc.). The similarity scores may be compared to a threshold (e.g., 0.9, 0.8, 0.7, etc.) to determine if there is a “match” between the two pieces of text such as in cell 314. If a match occurs, the sentence is considered to be valid and not a hallucination. But if any sentences in the summary do not have a match in the input text, the sentence is considered a hallucination.

In this example, the first sentence from the summary is matched to the first sentence from the input text as indicated by the similarity score of 0.92 in cell 314, which is above the predefined threshold of 0.90. Likewise, the second sentence from the summary is matched to the third sentence of the input text as indicated by the similarity score of 0.97. The third sentence from the summary, however, is not matched to any of the sentences in the input as noted by the similarity scores in the column of the third sentence are not above the predefined threshold of 0.90. Therefore, the third sentence from the summary is identified as a contextual hallucination by the software.

FIG. 3B illustrates a process 300B of identifying tokens of different types within input text and a summary according to an embodiment of the instant solution, and FIG. 3C illustrates a process 300C of detecting fact-based hallucinations based on the tokens of different types according to an embodiment of the instant solution. For example, the process 300B and the process 300C may correspond to the second stage 244 of the contextual determination process performed by the software application 240 that is shown and described with respect to FIG. 2C.

Referring to FIG. 3A, the software application may host or otherwise be communicably coupled to one or more named entity recognition (NER) models 320. The NER model(s) 320 may be customized to identify various tokens within the input text and the summary. For example, the NER model(s) 320 may receive the input text 212, the summary 224, and configuration data stored within a data frame 302 that identifies the type of token that the NER model(s) 320 should be looking for. In the example of FIG. 3B, the data frame 302 is capable of configuring a NER model to search for at least one of an email address, an IP address, a URL, and a date, within the text content, and extracting this data from the input content.

The NER model(s) may be machine learning model(s) used in natural language processing (NLP) to identify and categorize specific entities like people, locations, organizations, dates, and times within a text, extracting key information from the text by classifying them into predefined categories. In some embodiments, custom NER models may be used to extract entities (like emails, URLs, IP addresses, dates, etc.) in separate groups. Here, the NER model(s) 320 generate a group of tokens 322 corresponding to email addresses extracted from the input text 212 and a group of tokens 324 corresponding to email addresses extracted from the summary 224. If the model is working properly, the group of tokens 322 should match the group of tokens 324, or at least the group of tokens 324 should be found in the group of tokens 322.

Here, the system may also include a vectorizer 330 which can receive the group of tokens 322 and create a group of vectors 332 by embedding the group of tokens 322 into vector space. Likewise, the vectorizer 330 may receive the group of tokens 324 and create a group of vectors 342 by embedding the group of tokens 322 in vector space. This same process may be repeated for multiple categories of tokens, in addition to the email addresses. For example, similar processes may be performed for URLs, IP addresses, dates, and any other desired data that can be factual hallucinated.

The process shown in FIG. 3B may be performed prior to the process 300A shown in the FIG. 3A. For example, the group of tokens 322 may be deleted from the input text 212 by the software application 240 prior to comparing the input text 212 to the summary 224 to determine if any contextual hallucinations exists. Likewise, the group of tokens 324 may be deleted from the summary 224 by the software application 240 prior to comparing the input text 212 to the summary 224 to determine if any contextual hallucinations exists. This may result in a more accurate contextual hallucination because fact-based content can be analyzed separately.

Although not shown in FIG. 3B, the software application may include a regular expression (RegEx) model in addition to the NER model(s) 320. The RegEx model or models may be configured to use strings in the input text 212 and the summary 224 to perform matching. The RegEx model may identify a sequence of characters that specifies a match pattern in text. Usually such patterns are used by string-searching algorithms for “find” or “find and replace” operations on strings, or for input validation. Regular expression techniques are developed in theoretical computer science and formal language theory. A regex processor may translate a regular expression within either the summary 224 or the input text 212 into an internal representation that can be executed and matched against a string representing the text being searched. One possible approach is the Thompson's construction algorithm to construct a nondeterministic finite automaton (NFA), which is then made deterministic and the resulting deterministic finite automaton (DFA) is run on the target text string to recognize substrings that match the regular expression. The RegEx model may be used to identify matching sections of text that may not be captured by the NER model(s) 320, enabling a more comprehensive scoring process.

FIG. 3C illustrates a process 300C of detecting fact-based hallucinations based on the tokens of different types according to an embodiment of the instant solution. Referring to FIG. 3C, the process shown in FIG. 3B may result in groups of vectors 332, 334, 336 and 338 being generated from the input text 212 and groups of vectors 342, 344, 346, and 348 being generated from the summary 224. The software application may perform a distance determination between the groups of vectors, and in particular, in between individual vectors in the groups. For example, the vectors in the group of vectors 332 may be compared to the vectors in the group of vectors 342 resulting in a distance being determined between the vectors. To keep track of the distance values, the software may generate a distance determination grid 352 which is a two-dimensional array of cells where each cell corresponds to a vector comparison.

For example, a distance determination 350 may be determined between each vector in the group of vectors 332 with respect to each vector in the group of vectors 342. If there are no hallucinations, the vectors within the group of vectors 342 will be matched with a vector in the group of vectors 332. If, however, there is a hallucination, there will be a vector in the group of vectors 342 that is not supported by the vectors in the group of vectors 332.

FIG. 3D illustrates a scoring process 300D for hallucinations according to an embodiment of the instant solution. Referring to FIG. 3D, the distance determination 350 may generate scores for each of the different groups of vectors resulting in different scorecards 360, 361, and 362, in this example. Each scorecard contains the distance scores amongst the groups of vectors. Each of the different scorecards 360, 361, and 362 are examples of the distance determination grid 352 in the example of FIG. 3C. Here, for every row in a scorecard, a maximum value/distance score is identified. A value of 1 means that the entity is present in both source and summary. A value of 0 means that the entity is present in the summary but not in the input data. And a value between 0 and 1 means that the entity in the summary is similar to but not identical as another entity in the input text.

The average for all the max values of the rows is taken to generate a maximum average value 363 for the scorecard 362. The same process may be performed for the other scorecards resulting in a maximum value from each scorecard which can be added together to create an average score 364. Each model may have a raw score associated with it, which is generated at another time, or by another system. In this case, the software can adjust a raw score 365 of the model based on the average score 364 of the groups of vectors by multiplying the raw score 365 with the average score 364. The result is an adjusted model score 366 which can be used to identify the model when queried by external systems and users.

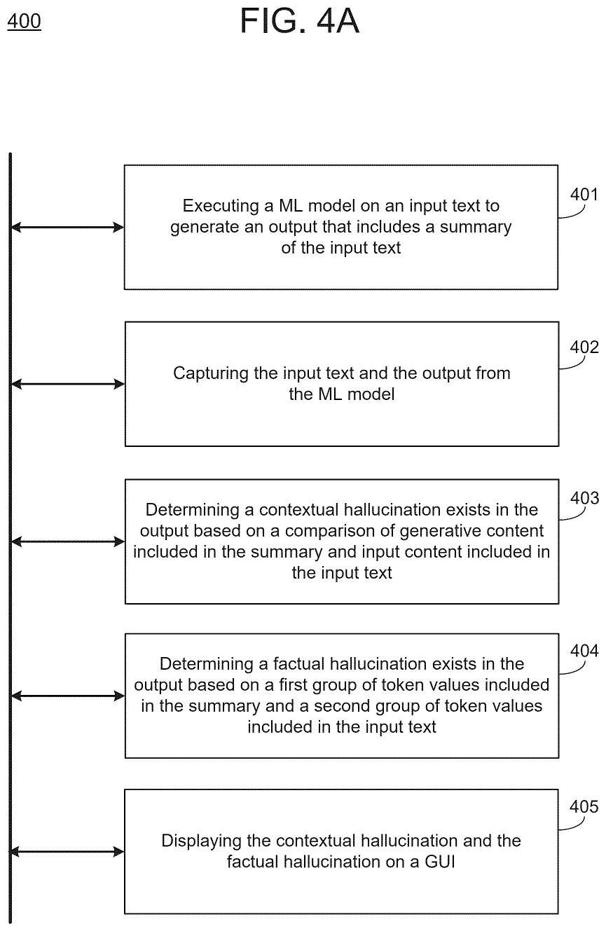

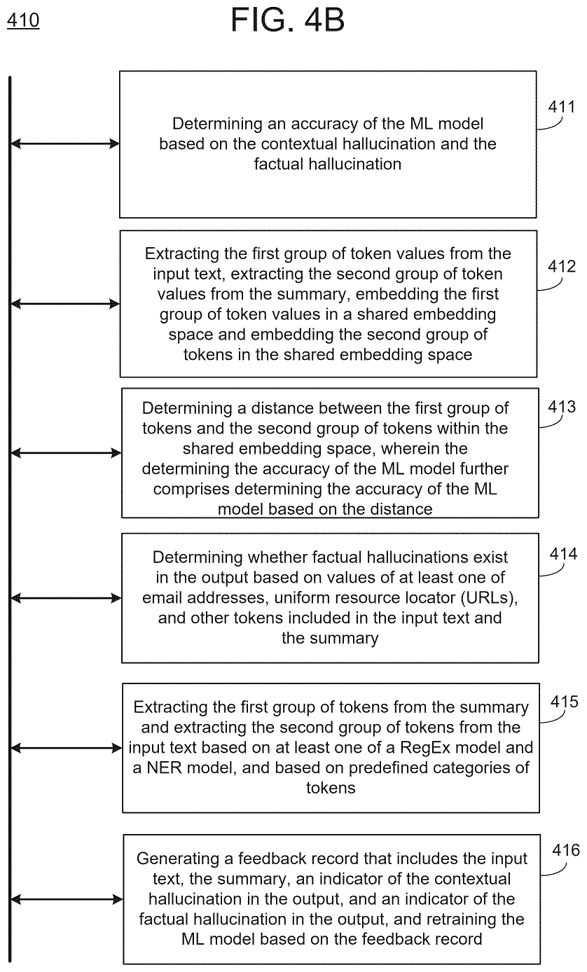

FIG. 4A illustrates a flow diagram of a method 400, according to example embodiments. Referring to FIG. 4A, in 401, the method may include executing a ML model on an input text to generate an output that comprises a summary of the input text. In 402, the method may include capturing the input text and the output from the ML model. In 403, the method may include determining a contextual hallucination exists in the output based on a comparison of generative content included in the summary and input content included in the input text. In 404, the method may include determining a factual hallucination exists in the output based on a first group of token values included in the summary and a second group of token values included in the input text. In 405, the method may include displaying the contextual hallucination and the factual hallucination on a graphical user interface (GUI).

FIG. 4B illustrates a flow diagram of a method 410, according to example embodiments. Referring to FIG. 4B, in 411, the method may include an accuracy of the ML model based on whether the contextual hallucinations exist in the output and whether the factual hallucinations exists in the output. In 412, the method may include extracting the first group of token values from the input text, extracting the second group of token values from the summary, embedding the first group of token values in a shared embedding space and embedding the second group of tokens in the shared embedding space.

In 413, the method may include determining a distance between the first group of tokens and the second group of tokens within the shared embedding space, wherein the determining the accuracy of the ML model further comprises determining the accuracy of the ML model based on the distance. In 414, the method may include determining whether factual hallucinations exist in the output based on values of at least one of email addresses, uniform resource locator (URLs), and other tokens included in the input text and the summary.

In 415, the method may include extracting the first group of tokens from the summary and extracting the second group of tokens from the input text based on at least one of a regular expression (RegEx) model and a named entity recognition (NER) model, and based on predefined categories of tokens. In 416, the method may include generating a feedback record that includes the input text, the summary, an indicator of whether the contextual hallucinations exist in the output, and an indicator of whether the factual hallucinations exists in the output, and retraining the ML model based on the feedback record.

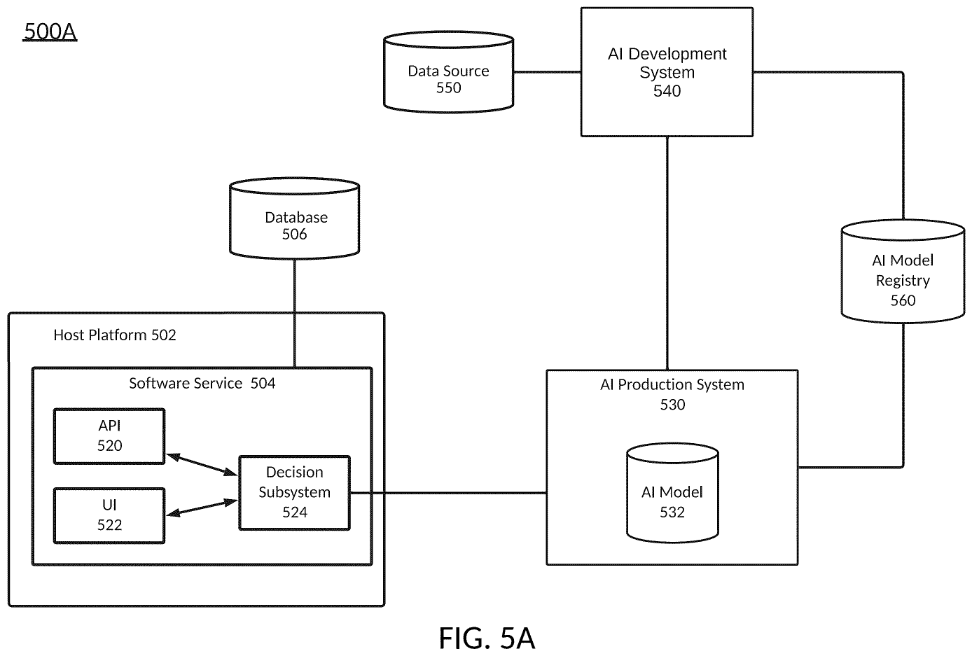

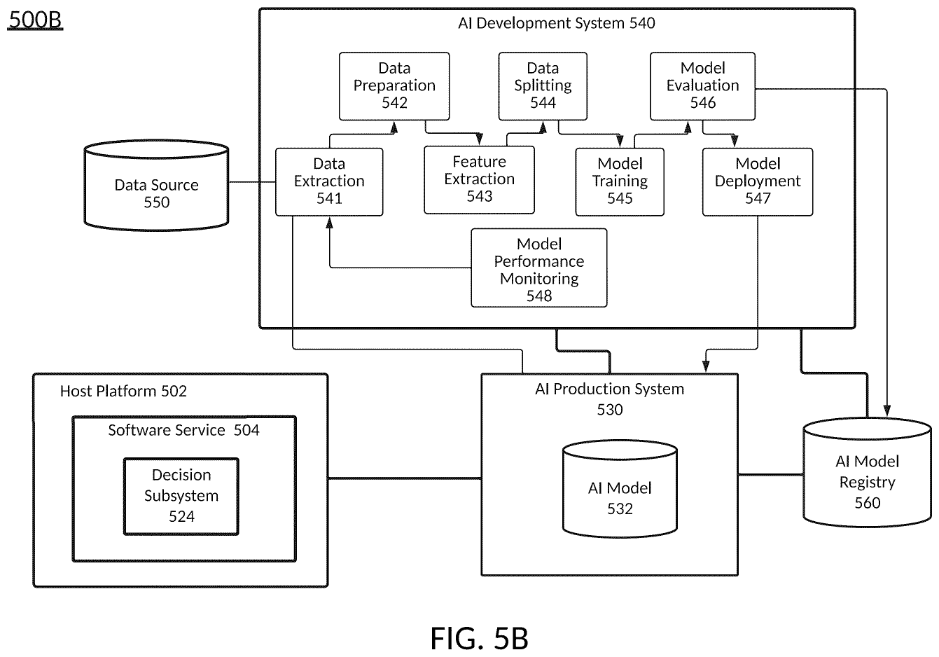

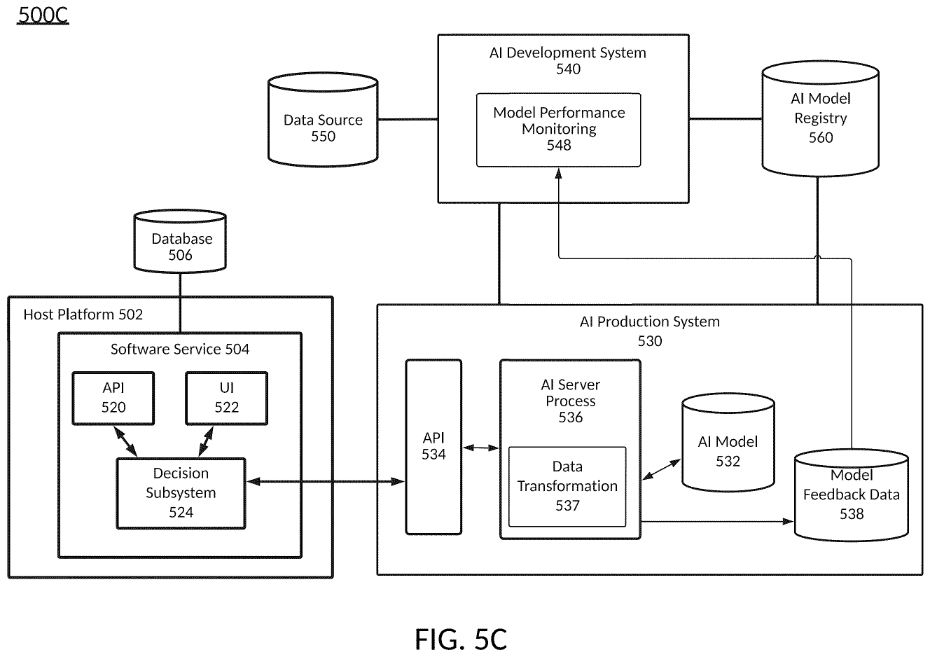

Detailed descriptions of training a machine learning model and executing a machine learning model are further described and depicted herein. The training and executing of the machine learning model described in the examples of FIGS. 5A-5C may be performed inside a confidential machine learning computing environment as described in the examples herein.

FIG. 5A illustrates an artificial intelligence (AI) network diagram 500A that supports AI-assisted decision points in a software service executing on a computer. As one example, the AI model being trained in the examples herein may refer to an AI model for any of the tasks performed herein including a machine learning model, a neural network, a large language model (LLM), and the like. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities rely on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Artificial intelligence systems have been built and trained to perform various tasks in an automated manner. For example, artificial intelligence systems receive and understand verbal and/or written dialogue and function as digital assistants, speech-to-text programs, etc. Other artificial intelligence systems are trained on different types of information to allow the trained system to generate content-such as new works of art based on the styles seen, or new compound ideas based on the history of chemical research.

Foundation models are types of artificial intelligence systems that are trained on a broad set of unlabeled data that can be used for different tasks, with minimal fine-tuning. The unlabeled data includes in some instances imagery and/or language. In response to a short prompt being input into the foundation model, the system generates an output such as an entire essay, or a complex image, based on the parameters that are set forth in the input prompt. The foundation model is able to produce an output that attempts to meet the parameters even if the foundation model was never trained with specific training data that included the exact parameters, e.g., was never trained for that exact argument or to generate an image in that way.

Using self-supervised learning and transfer learning, foundation models can apply information that they have learnt about one situation to another. For example, like a human learns how to drive on one car, for example, and without too much effort, could learn how to drive other types of vehicles such as other cars, a truck, or a bus. The foundation model similarly is used to achieve proficiency in some new area without having to be trained completely from scratch. Foundation models seem to have inherent creativity in performing tasks such as stringing together coherent arguments or create entirely original pieces of art. Foundation models are established in the technology of natural-language processing. One example of how foundation models are helpful is that for previous generation of AI techniques, if you wanted to build an AI model that could summarize bodies of text for you, you would need tens of thousands of labeled examples just for the summarization use case. With a pre-trained foundation model, the labeled data requirements are dramatically reduced. First, the foundation model is fine-tuned with a domain-specific unlabeled corpus to create a domain-specific foundation model. Then, using a much smaller amount of labeled data, potentially just a thousand labeled examples, a foundation model is trained for summarization. The domain-specific foundation model can be used for many tasks as opposed to the previous technologies that required building models from scratch in each use case. Foundation models are even applicable in areas such as computer programming coding analysis, generation, and repair.

Some foundation models are used for sentiment analysis. With pre-trained foundation models, sentiment analysis on a new language can be trained using as little as a few thousand sentences—100 times fewer annotations required than previous models. Reducing labeling requirements will make it much easier for implementation in various technical areas. Systems that execute specific tasks in a single domain are giving way to broad AI that learns more generally and works across domains and problems. Foundation models, trained on large, unlabeled datasets and fine-tuned for an array of applications, are driving this shift.

Large language models (LLMs) are a category of foundation models trained on immense amounts of data making them capable of understanding and generating natural language and other types of content to perform a wide range of tasks. LLMs have been implemented at different levels to enhance their natural language understanding (NLU) and natural language processing (NLP) capabilities. This advancement of LLMs has occurred alongside advances in machine learning, machine learning models, algorithms, neural networks and the transformer models that provide the architecture for these AI systems.

LLMs are a class of foundation models, which are trained on enormous amounts of data to provide the foundational capabilities needed to drive multiple use cases and applications, as well as resolve a multitude of tasks. This LLM concept is in stark contrast to the idea of building and training domain specific models for each of these use cases individually, which is prohibitive under many criteria (most importantly cost and infrastructure), stifles synergies and can even lead to inferior performance.

LLMs represent a significant breakthrough in NLP and artificial intelligence. LLMs are accessible through interfaces like Open AI's Chat GPT-3 and GPT-4, which have garnered the support of Microsoft. Other examples include Meta's Llama models and Google's bidirectional encoder representations from transformers (BERT/RoBERTa) and PaLM models. IBM has also recently launched its Granite model series on watsonx. ai, which has become the generative AI backbone for other IBM products like watsonx Assistant and watsonx Orchestrate.

In a nutshell, LLMs are designed to understand and generate text like a human, in addition to other forms of content, based on the vast amount of data used to train them. They have the ability to infer from context, generate coherent and contextually relevant responses, translate to languages other than English, summarize text, answer questions (general conversation and FAQs) and even assist in creative writing or code generation tasks. LLMs are able to do some or all of these tasks thanks to many, e.g., billions of, parameters that enable them to capture intricate patterns in language and perform a wide array of language-related tasks. LLMs are revolutionizing applications in various fields, from chatbots and virtual assistants to content generation, research assistance and language translation.

LLMs operate by leveraging deep learning techniques and vast amounts of textual data. These models are typically based on a transformer architecture, like the generative pre-trained transformer, which excels at handling sequential data like text input. LLMs consist of multiple layers of neural networks, each with parameters that can be fine-tuned during training, which are enhanced further by a numerous layer known as the attention mechanism, which dials in on specific parts of data sets.

During the training process, these models learn to predict the next word in a sentence based on the context provided by the preceding words. The model does this through attributing a probability score to the recurrence of words that have been tokenized—broken down into smaller sequences of characters. These tokens are then transformed into embeddings, which are numeric representations of this context.

To ensure accuracy, this process involves training the LLM on a large corpus of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive, and drawing on the patterns and knowledge they have acquired. The result is coherent and contextually relevant language generation that can be harnessed for a wide range of NLU and content generation tasks.

Model performance can also be increased through prompt engineering, prompt-tuning, fine-tuning and other tactics like reinforcement learning with human feedback (RLHF) to remove the biases, hateful speech and factually incorrect answers known as “hallucinations” that are often unwanted byproducts of training on so much unstructured data. LLMs augment conversational AI in chatbots and virtual assistants to enhance the interactions that provide context-aware responses that mimic interactions with human agents.

LLMs also excel in content generation, automating content creation for blog articles, explanatory materials, and other writing tasks. LLMs aid in summarizing and extracting information from vast datasets, accelerating knowledge discovery. LLMs also play a vital role in language translation, breaking down language barriers by providing accurate and contextually relevant translations. LLMs can even be used to write code, or “translate” between programming languages. LLMs contribute to accessibility by assisting individuals with disabilities, including text-to-speech applications and generating content in accessible formats.

LLMs often include abilities such as:
Text generation: language generation abilities, such as writing emails, blog posts or other mid-to-long form content in response to prompts that can be refined and polished. An excellent example is retrieval-augmented generation (RAG).
Content summarization: summarize long articles, news stories, research reports, corporate documentation and even interaction history into thorough texts tailored in length to the output format.
AI assistants: chatbots that answer queries, perform backend tasks and provide detailed information in natural language as a part of an integrated, self-serve solution for handling inquiries.
Code generation: assists developers in building applications, finding errors in code and uncovering security issues in multiple programming languages, even “translating” between them.
Sentiment analysis: analyze text to determine a user's tone in order to understand user feedback at scale and aid in brand reputation management.
Language translation: provides wider coverage to organizations across languages and geographies with fluent translations and multilingual capabilities.

Software service 504 (see FIG. 5A), executing on host platform 502 (see FIG. 5A) may provide one or more application programming interfaces (APIs) 520 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 520 send data to one or more decision subsystems 524 of the software service 504 to assist in decision-making. In some examples and features of the instant solution, the software service 504 stores data included in API requests or data generated during processing the API requests into one or more databases 506 (see FIG. 5A).

Software service 504 may provide one or more user interfaces (UIs) 522, such as a server-side hosted graphical user interface (GUI). In some examples and features of the instant solution, the UIs 522 provided employ template-based frameworks, component-based frameworks, etc. In some examples and features of the instant solution, these UIs 522 send data to one or more decision subsystems 524 of the software service 504 to assist with decision-making. In some examples and features of the instant solution, the software service 504 stores data included in UI requests or data generated during processing the UI requests into one or more databases 506.

Software service 504 may include one or more decision subsystems 524 that drive a decision-making process of the software service 504. In some examples and features of the instant solution, the decision subsystems 524 receive data from one or more APIs 520 as input into the decision-making process. In some examples and features of the instant solution, a decision subsystem 524 may receive data from one or more UIs 522 as input to the decision-making process. A decision subsystem 524 may gather service configuration or historical execution data from one or more databases 506 to aid in the decision-making process. A decision subsystem 524 may provide feedback to an API 520 or a UI 522.

An AI production system 530 may be used by a decision subsystem 524 in a software service 504 to assist in its decision-making process. The AI production system 530 includes one or more AI models 532 that are executed to generate a response, such as, but not limited to, a prediction, a categorization, a UI prompt, etc. In some examples and features of the instant solution, an AI production system 530 is hosted on a server. In some examples and features of the instant solution, the AI production system 530 is cloud-hosted. In some examples and features of the instant solution, the AI production system 530 is deployed in a distributed multi-node architecture.

An AI development system 540 creates one or more AI models 532. In some examples and features of the instant solution, the AI development system 540 utilizes data from one or more data sources 550 to develop and train one or more AI models 532. The data sources 550 may be local or third-party data sources. Further, the data provided by the data sources may be real-world or synthetic. In some examples and features of the instant solution, the AI development system 540 utilizes feedback data from one or more AI production systems 530 for new model development and/or existing model re-training. In some examples and features of the instant solution, the AI development system 540 resides and executes on a server. In some examples and features of the instant solution, the AI development system 540 is cloud hosted. In some examples and features of the instant solution, the AI development system 540 is deployed in a distributed multi-node architecture. In some examples and features of the instant solution, the AI development system 540 utilizes a distributed data pipeline/analytics engine.

Once an AI model 532 has been trained and validated in the AI development system 540, it may be stored in an AI model registry 560 for retrieval by either the AI development system 540 or by one or more AI production systems 530. The AI model registry 560 resides in a dedicated server in one example of the instant solution. In some examples and features of the instant solution, the AI model registry 560 is cloud-hosted. In some examples and features of the instant solution, the AI model registry 560 resides in the AI production system 530. In some examples and features of the instant solution, the AI model registry 560 is a distributed database.

FIG. 5B illustrates a process 500B for developing one or more AI models that support AI-assisted decision points. An AI development system 540 executes steps to develop an AI model 532 that begins with data extraction 541, in which data is loaded and ingested from one or more data sources 550. In some examples and features of the instant solution, historical model feedback data is extracted from one or more AI production systems 530.

Once the data has been extracted during data extraction 541, it undergoes data preparation 542 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 542 may be a manual process or an automated process using one or more of the elements and/or functions described and/or depicted herein.

Features of the data are identified and extracted during the feature extraction step 543. In some examples and features of the instant solution, a feature of the data is internal to the prepared data from the data preparation step 542. In some examples and features of the instant solution, a feature of the data requires a piece of prepared data from the data preparation step 542 to be enriched by data from another data source to be useful in developing the AI model 532. In some examples and features of the instant solution, identifying relevant features (relevant attributes) for model training are performed via an automated process using one or more of the elements and/or functions described and/or depicted herein. Once the features have been identified, the values of the features are collected into a dataset that will be used to develop the AI model 532.

The dataset output from the feature extraction step 543 is split 544 into a training and validation data set. The training data set is used to train the AI model 532, and the validation data set is used to evaluate the performance of the AI model 532 on unseen data.

The AI model 532 is trained and tuned 545 using the training data set from the data splitting step 544. In this step, the training data set is provided to an AI algorithm and an initial set of algorithm parameters which may be automatically determined based on the interdependence between the relevant attributes determined according to various embodiments. The performance of the AI model 532 is then tested within the AI development system 540 utilizing the validation data set from step 544. These steps may be repeated with adjustments to one or more algorithm parameters until the model's performance is acceptable based on various goals and/or results.

The AI model 532 is evaluated 546 in a staging environment (not shown) that resembles the target AI production system 530. This evaluation uses a validation dataset to ensure the performance in an AI production system 530 matches or exceeds expectations. In some examples and features of the instant solution, the validation dataset from step 544 is used. In some examples and features of the instant solution, one or more unseen validation datasets are used. In some examples and features of the instant solution, the staging environment is part of the AI development system 540, and the staging environment is managed separately from the AI development system 540. Once the AI model 532 has been validated, it is stored in an AI model registry 560, where it can be retrieved for deployment and future updates. In some examples and features of the instant solution, the model evaluation step 546 may be a manual process or an automated process using one or more of the elements and/or functions described and/or depicted herein.

In some examples and features of the instant solution, the AI development system includes a user interface (not shown). The user interface may be used to manage the development system infrastructure, the steps 541-548 within the development system, the interim data transmitted between the various steps 541-548, and the data sources 550.

Once an AI model 532 has been validated and published to an AI model registry 560, it may be deployed during the model deployment step 547 to one or more AI production systems 530. In some examples and features of the instant solution, the performance of deployed AI model 532 is monitored 548 by the AI development system 540. In some examples and features of the instant solution, AI model 532 feedback data is provided by the AI production system 530 to enable model performance monitoring 548, and the AI development system 540 periodically requests feedback data for model performance monitoring 548, which includes one or more triggers that result in the AI model 532 being updated by repeating steps 541-548 with updated data from one or more data sources 550.

FIG. 5C illustrates a process 500C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 5C, an AI production system 530 may be used by a decision subsystem 524 in software service 504 to assist in its decision-making process. The AI production system 530 provides an API 534, executed by an AI server process 536 through which requests can be made. In some examples and features of the instant solution, a request may include an AI model 532 identifier to be executed based on the type of request. In some examples and features of the instant solution, a data payload (e.g., to be input to the AI model during execution) is included in the request. The data payload may include API 520 data from software service 504, UI 522 data from software service 504 or data from other software service 504 subsystems (not shown).

Upon receiving the API 534 request, the AI server process 536 may transform 537 the data payload or portions of the data payload to be valid feature values in an AI model 532. Data transformation 537 may include, but is not limited to, combining data values, normalizing data values, and enriching the incoming data with data from other data sources 550. Once the data transformation occurs, the AI server process 536 executes the appropriate AI model 532 using the transformed input data. Upon receiving the execution result, the AI server process 536 responds to the API requester, which is a decision subsystem 524 of software service 504. In some examples and features of the instant solution, the response may result in an update to a UI 522 in software service 504. In some examples and features of the instant solution, the response includes a request identifier that can be used later by the software service 504 to provide feedback on the performance of the AI model 532. In some examples and features of the instant solution, a model feedback record may be added into a model feedback data 538 by the AI server process 536.

In some examples and features of the instant solution, the API 534 includes an interface to provide AI model 532 feedback after an AI model 532 execution response has been processed. This mechanism enables the requester to provide feedback on the accuracy of the AI model 532 results. In some examples and features of the instant solution, the feedback interface includes the identifier of the initial request so that it can be used to associate the feedback with the request. Upon receiving a call into the feedback interface of the API 534, the AI server process 536 creates and adds a model feedback record into the model feedback data 538 which holds historical model feedback records. In some examples and features of the instant solution, the records in this model feedback data 538 are provided to model performance monitoring 548 in the AI development system 540. This model feedback data is streamed to the AI development system 540 or may be provided upon request. In some examples and features of the instant solution, the model feedback records in the model feedback data 538 are used as an input for retraining the AI model 532.

In some examples and features of the instant solution, the AI production system 530 includes a user interface (not shown). The user interface may be used to manage the production system infrastructure, the components of the production system 530-538, and the operation of the AI production system and its components.

The above embodiments may be implemented in hardware, in a computer program executed by a processor, in firmware, or in a combination of the above. A computer program may be embodied on a computer-readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A method comprising:
executing a machine learning (ML) model on an input text to generate an output that comprises a summary of the input text;
capturing the input text and the output from the ML model;
determining a contextual hallucination exists in the output based on a comparison of generative content included in the summary and input content included in the input text;
determining a factual hallucination exists in the output based on a first group of token values included in the summary and a second group of token values included in the input text; and
displaying the contextual hallucination and the factual hallucination on a graphical user interface (GUI).

2. The method of claim 1, further comprising determining an accuracy of the ML model based on the contextual hallucination and the factual hallucination.

3. The method of claim 2, further comprising extracting the first group of token values from the input text, extracting the second group of token values from the summary, embedding the first group of token values in a shared embedding space and embedding the second group of tokens in the shared embedding space.

4. The method of claim 3, further comprising determining a distance between the first group of tokens and the second group of tokens within the shared embedding space, wherein the determining the accuracy of the ML model further comprises determining the accuracy of the ML model based on the distance.

5. The method of claim 1, wherein the determining whether factual hallucinations exist in the output comprises determining whether factual hallucinations exist in the output based on values of at least one of email addresses, uniform resource locator (URLs), and other tokens included in the input text and the summary.

6. The method of claim 1, further comprising extracting the first group of tokens from the summary and extracting the second group of tokens from the input text based on at least one of a regular expression (RegEx) model and a named entity recognition (NER) model, and based on predefined categories of tokens.

7. The method of claim 1, further comprising generating a feedback record that includes the input text, the summary, an indicator of the contextual hallucination in the output, and an indicator of the factual hallucination in the output, and retraining the ML model based on the feedback record.

8. A computer system comprising:
a processor set;
a set of one or more computer-readable storage media; and
program instructions, collectively stored in the set of one or more storage media, that cause the processor set to perform computer operations comprising:
executing a machine learning (ML) model on an input text to generate an output that comprises a summary of the input text;
capturing the input text and the output from the ML model;
determining a contextual hallucination exists in the output based on a comparison of generative content included in the summary and input content included in the input text;
determining a factual hallucination exists in the output based on a first group of token values included in the summary and a second group of token values included in the input text; and
displaying the contextual hallucination and the factual hallucination on a graphical user interface (GUI).

9. The computer system of claim 8, wherein the computer operations further comprise determining an accuracy of the ML model based on the contextual hallucination and the factual hallucination.

10. The computer system of claim 9, wherein the computer operations further comprise extracting the first group of token values from the input text, extracting the second group of token values from the summary, embedding the first group of token values in a shared embedding space and embedding the second group of tokens in the shared embedding space.

11. The computer system of claim 10, further comprising determining a distance between the first group of tokens and the second group of tokens within the shared embedding space, wherein the determining the accuracy of the ML model further comprises determining the accuracy of the ML model based on the distance.

12. The computer system of claim 8, wherein the determining whether factual hallucinations exist in the output comprises determining whether factual hallucinations exist in the output based on values of at least one of email addresses, uniform resource locator (URLs), and other tokens included in the input text and the summary.

13. The computer system of claim 8, further comprising extracting the first group of tokens from the summary and extracting the second group of tokens from the input text based on at least one of a regular expression (RegEx) model and a named entity recognition (NER) model, and based on predefined categories of tokens.

14. The computer system of claim 8, further comprising generating a feedback record that includes the input text, the summary, an indicator of the contextual hallucination in the output, and an indicator of the factual hallucination in the output, and retraining the ML model based on the feedback record.

15. A computer program product comprising:
a set of one or more computer-readable storage media; and
program instructions, collectively stored in the set of one or more computer-readable storage media, for causing a processor set to perform computer operations comprising:
executing a machine learning (ML) model on an input text to generate an output that comprises a summary of the input text;
capturing the input text and the output from the ML model;
determining a contextual hallucination exists in the output based on a comparison of generative content included in the summary and input content included in the input text;
determining a factual hallucination exists in the output based on a first group of token values included in the summary and a second group of token values included in the input text; and
displaying the contextual hallucination and the factual hallucination on a graphical user interface (GUI).

16. The computer program product of claim 15, wherein the computer operations further comprise determining an accuracy of the ML model based on the contextual hallucination and the factual hallucination.

17. The computer program product of claim 16, wherein the computer operations further comprise extracting the first group of token values from the input text, extracting the second group of token values from the summary, embedding the first group of token values in a shared embedding space and embedding the second group of tokens in the shared embedding space.

18. The computer program product of claim 17, wherein the computer operations further comprise determining a distance between the first group of tokens and the second group of tokens within the shared embedding space, wherein the determining the accuracy of the ML model further comprises determining the accuracy of the ML model based on the distance.

19. The computer program product of claim 15, wherein the determining whether factual hallucinations exist in the output comprises determining whether factual hallucinations exist in the output based on values of at least one of email addresses, uniform resource locator (URLs), and other tokens included in the input text and the summary.

20. The computer program product of claim 15, wherein the computer operations further comprise generating a feedback record that includes the input text, the summary, an indicator of the contextual hallucination in the output, and an indicator of the factual hallucination in the output, and retraining the ML model based on the feedback record.
